(19) United States
(12) Patent Application Publication
(10) Pub. No.: US 2006/0173898 A1
(43) Pub. Date: Aug. 3, 2006

(54) Mis-sort verification system and method of use

(76) Inventor: Bruce H. Hanson, Endicott, NY (US)

Correspondence Address: GREENBLUM & BERNSTEIN, P.L.C., 1950 ROLAND CLARKE PLACE, RESTON, VA, 20191, US

(21) Appl. No.: 11/048,725

(22) Filed: Feb. 3, 2005

(51) Int. Cl. G06F 17/00

(52) U.S. Cl. 707/102

(57) ABSTRACT

A method or process and system of confirming an ordering of products includes generating a database of product information associated with a plurality of product and comparing the product information of the plurality of product in a sorting pass process to the product information assigned in the database to verify an order of the plurality of product in the sorting pass process. The process may additionally include reading pertinent information associated with a plurality of product during a sorting operation and populating a database with the pertinent information for use during a subsequent sorting operation. In the subsequent sorting operation, the process includes comparing what is actually read during the subsequent sorting operation against what should have been read based on assignments made in the database of the pertinent information during the sorting operation.

### FIELD OF THE INVENTION

The invention generally relates to a sequencing system and method of use and, more particularly, to a system and method to verify and/or correct product placement during sorting operations.

### BACKGROUND DESCRIPTION

The sorting of mail or other types of objects or product is a very complex, time consuming task. In general, the sorting of product such as mail pieces, for example, is processed through many stages, including processes which sort or sequence the products in delivery order sequence. These processes can either be manual or automated, depending on the sorting facility, the type of product to be sorted such as packages, flats and letters and the like. A host of other factors may also contribute to the automation of the sorting, from budgetary concerns to modernization initiatives to access to appropriate technologies to a host of other factors.

In general, however, most modern facilities have taken major steps toward automation by the implementation of a number of technologies. These technologies include, amongst others, automated and semi-automated machinery which sort and sequence, parcels, flat, mail pieces and the like. As a result of these developments, postal facilities and other handling facilities have become quite automated over the years, considerably reducing overhead costs. Without these systems, it would be virtually impossible for a postal service such as the United States Postal Service (USPS) to efficiently delivery mail pieces in a time sensitive and cost efficient manner.

At many facilities, the mail pieces are sorted and then sequenced in delivery point order using a multiple pass process. In such a multiple pass process, the mail pieces are inducted into a feeding device, scanned by bar code readers or optical character recognition (OCR) and transported to a bin location, resulting in a sort order of the mail pieces. Once the mail pieces are in a sort order, e.g., first pass operation is complete; the sorted mail pieces are then inducted into the feeding device, in the sorted order, for sequencing operations.

In a more specific example using a two pass operation, directions are assigned to a set of delivery points, all of which are assigned to output bins or holding trays of the system. Taking four directions with 16 delivery points, for example, a first portion of the operation may assign the following directions to each mail piece for a particular delivery point.

| | |
|---|---|
| Directions | Delivery Points |

| | | | | |
|---|---|---|---|---|
| Direction #1 | 1 | 5 | 9 | 13 |
| Direction #2 | 2 | 6 | 10 | 14 |
| Direction #3 | 3 | 7 | 11 | 15 |
| Direction #4 | 4 | 8 | 12 | 16 |

However, these sets of delivery points are not in any particular order, resulting only in a sort level ordering of the mail pieces after completion of first pass operations.

After the first pass operations, the holding trays are removed from the system, and the mail pieces are then fed back through the induction point for second pass operations, e.g., sequencing operations. In doing so, it is now possible to reassign the directions in the following manner, for example,

| | |
|---|---|
| Directions | Delivery Points |

| | | | | |
|---|---|---|---|---|
| Direction #1 | 1 | 2 | 3 | 4 |
| Direction #2 | 5 | 6 | 7 | 8 |
| Direction #3 | 9 | 10 | 11 | 12 |
| Direction #4 | 13 | 14 | 15 | 16 |

Now, each of the mail pieces is transported to a direction, resulting in a sequenced stream. Specifically, direction 1 has delivery points for 1, 2, 3 and 4. Direction 2 has delivery points for 5, 6, 7, and 8. Direction 3 has delivery points for 9, 10, 11 and 12. Lastly, direction 4 has delivery points for 13, 14, 15 and 16.

Although the use of multiple pass operations provides great improvements over manual sorting and sequencing, such operations may still have misplaced mail pieces running through the system, during second or subsequent sorting operations, thus disrupting the sequencing operations. The misplaced mail pieces may be due to several reasons, amongst them being:
Undetected “doubles” caused by a failure of the feeder to completely singulate all mail pieces during a first pass operation.
One or more mail pieces, not previously scanned and sorted, being inserted into the stream of sorted mail pieces during the second pass operation.
One or more mail pieces fed in a different order than which was provided after the first sort operation. This may be the result of an operator incorrectly inserting a mail piece into the feeder after it has been accidentally removed or fallen out of order from the stream.
Machine error.

Thus, in these and other situations, the misplaced mail pieces or other type of product may continue throughout the remaining operations, which is problematic. This may result in mis-delivered product or a large volume of rejected product. In any case, these system constraints may reduce overall efficiency of the system while increasing overhead and related costs.

### SUMMARY OF THE INVENTION

In a first aspect of the invention, a method of confirming an ordering of products includes generating a database of product information associated with a plurality of product and comparing the product information of the plurality of product in a sorting pass process to the product information assigned in the database to verify an order of the plurality of product in the sorting pass process.

In another aspect of the invention, a process for increasing machine efficiency includes reading pertinent information associated with a plurality of product during a sorting operation and populating a database with the pertinent information for use during a subsequent sorting operation. In the subsequent sorting operation, the process includes reading the pertinent information associated with the plurality of product and accessing the database and comparing what is actually read during the subsequent sorting operation against what should have been read based on assignments made in the database of the pertinent information during the sorting operation. Based on this determination, the plurality of product can be sequenced.

A computer program product is also provided. The computer program product increases an accuracy of sorting operations based on method steps of the invention.

### BRIEF DESCRIPTION OF THE DRAWINGS

FIG. 1 shows a schematic view of a system used in accordance with the invention;

FIG. 2 is a flow diagram showing the steps implementing the invention; and

FIGS. 3a and 3b is a flow diagram showing the steps implementing the invention.

### DETAILED DESCRIPTION OF EMBODIMENTS OF THE INVENTION

The invention is directed to a system and method for increasing machine accuracy and throughput. In an aspect of the invention, the system and method increases machine accuracy and throughput of mail pieces such as packages, flats, mixed mail and the like (generally referred hereinafter as product). The system and method may also significantly reduce processing times for sequencing the products in delivery point sequence using, in an embodiment, a verification system. Other applications such as warehousing and storage applications are also contemplated for use with the invention.

In the invention, the product is scanned during preliminary pass or sorting operations and the pertinent information is downloaded or populated into a database for use during a subsequent sorting or sequencing operation. In this preliminary operational stage, for example, product are numbered in the database according to the order in which they were presented to the detection device such as, for example, an optical reader (OCR) or bar code reader (BCR) during a subsequent sorting operation. During the subsequent operational stage, the database will be accessed and a comparison will be made between what is actually seen by the detection device against what should have been seen based on the assignments made in the database. By this comparison, anomalies can be detected and remedied. The remedy is intended to maximize sorted pieces, in addition to maintaining absolute accuracy.

### Sequencing System of the Invention

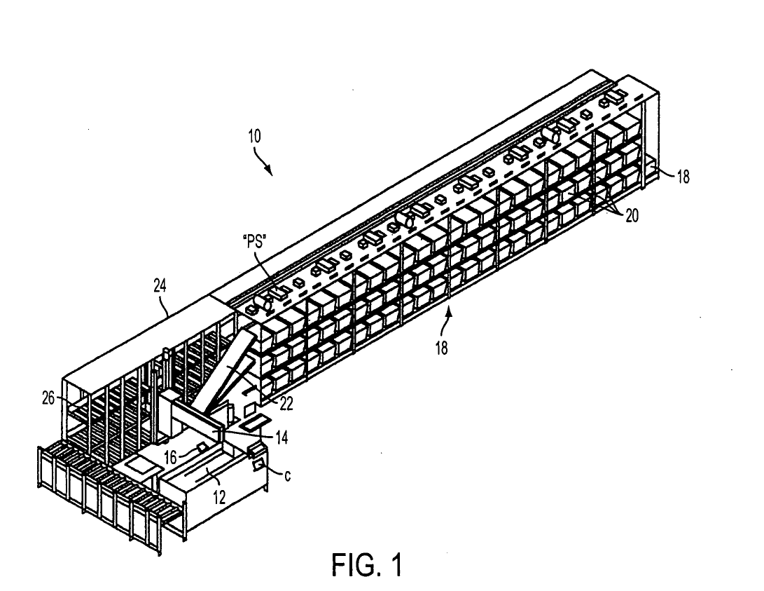

Referring now to FIG. 1, a schematic diagram of one exemplary sequencing system is shown. It should be recognized, though, that the invention may be implemented on a number of different types of systems, and that the invention should not be limited only to the exemplary system shown in FIG. 1. For example, the invention can be implemented on any number of different types of machines manufactured by Lockheed Martin Corporation.

In the embodiment of FIG. 1, the system is generally depicted as reference numeral 10 and includes an induction point or input feeding device 12. In the embodiment of FIG. 1, one input feeding device is shown for illustration; however, the system may use any number of input feeding devices such as two, three or more input feeding devices depending on the particular application. In use, an operator will manually provide product to the feeding device 12 and more particularly to a loading ledge.

In one embodiment, the input feeding device 12 includes an inserter 14 and a detection device 16 such as an optical recognition reader (OCR) or a bar code reader (BCR), all communicating and controlled by a controller “C”. The inserter 14 has a feed rate capacity of approximately 40,000 letters per hour; however, other feeding capacity rates may also be used with the invention.

Referring still to FIG. 1, the inserter 14 directs the product to a transporting system 18 which transports the products to output bins 20. In one aspect of the invention, the products, of product stream “PS”, are inducted into the input feeding device via the inserter 14 in any random order. The detection device 16 will read a destination identifier associated with each of the products such as an address or the like, which information will be used to generate a database, e.g., first pass or preliminary pass database. Although the database may be referred to as a first pass database, it should be understood that the database can also equally be generated on any subsequent or preliminary pass operations and that the designation “first” should not be construed as limited to only a database generated during a first pass operation. For example, this operational stage may be a preliminary stage operation. Thereafter, the product will be transported to a respective output bin 20 via the transporting system 18 under the control of controller “C”.

In an embodiment, a grouping of contiguous output bins 20 may be designated for any number of respective carrier routes. In this particular embodiment, 72 output bins are provided; although, any number of output bins may be provided and are contemplated by the invention. Also, the output bins 20 may be on different levels, which are accessible by incline section 22, controlled by controller “C”. This allows the system 10 to accommodate a large number of tubs (trays) on a plurality of levels in a space of relatively small horizontal extent. In one implementation, the appropriate level of the transport 14 is selected in accordance with the less/least significant digits or characters of the destination identifier (e.g. zip code) determined by the detection device.

When a first or other preliminary pass operation is complete, the tubs are moved to return conveyor 24. The tubs are then presented, in order, to the operator. As illustrated, the return conveyor 24 preferably includes an elevator mechanism 26 which returns the tubs to a single level while maintaining their order. As the tubs are presented to the operator, the operator will place the contents of each tub on the feeding ledge 12 for further induction. The sorting process is then repeated for second or subsequent sorting operations. During this operational stage, the first pass database will be accessed and a comparison will be made between what is actually seen by the detection device against what should have been seen based on the database contents. By this comparison, anomalies can be detected and remedied.

### Method of Sequencing Product using the System of the Invention

The system of the invention may be used for a single carrier route at a time, multiple routes at once or for warehousing or other sorting needs of products. In one implementation, the system uses a two-pass sort scheme to sequence the product using one or more input feeding devices in operational stages described herein; although the system and method will work equally well with other multiple pass operations. During the second or subsequent operational stage, a comparison is made between product information of the database and product inducted into the system, during the subsequent operational stage, to verify sort order of the product.

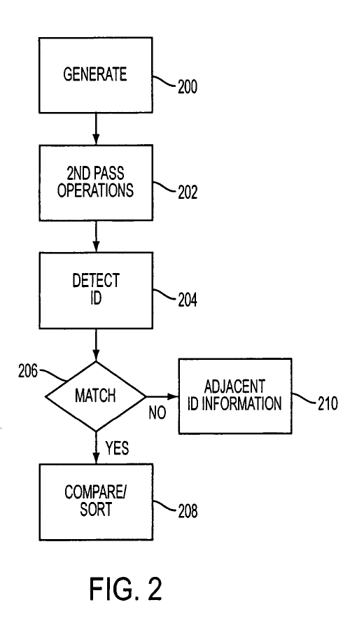

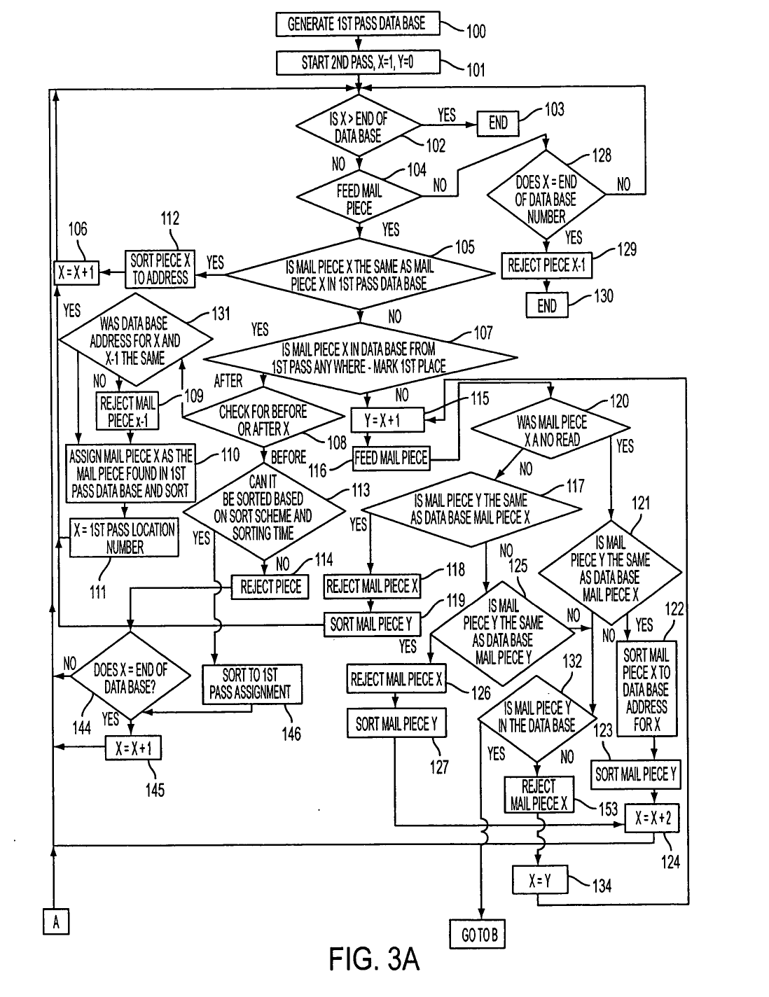

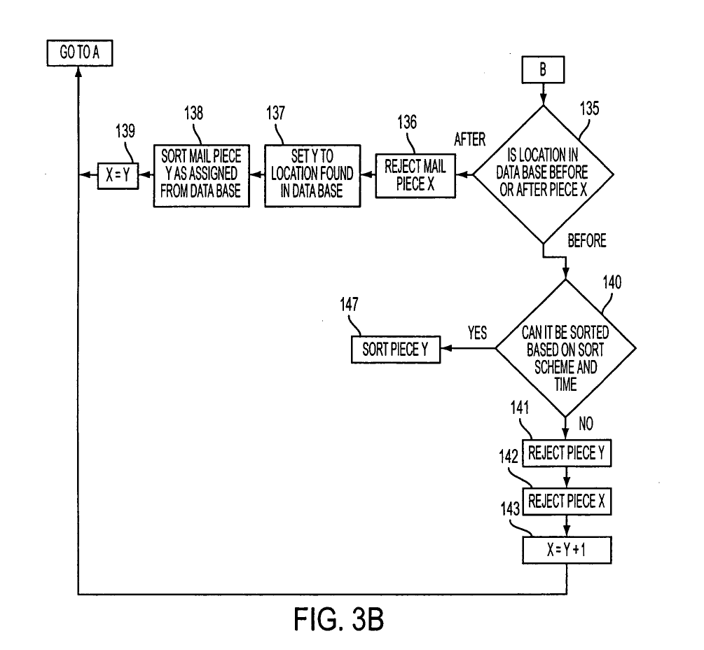

FIGS. 2-3b are flow diagrams implementing the steps of the invention. The controller “C” may be used to implement such steps of the invention as shown in the flow diagrams. FIGS. 2-3b may equally represent a high-level block diagram of components of the invention implementing the steps thereof. The steps of FIGS. 2-3b may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The steps of the flow diagrams may be implemented on the system of FIG. 1.

Referring to FIG. 2, at step 200, a database of product designations and/or product information is generated during a first sort operation. The database may include future assignments for sorting of the product in subsequent pass operations. At step 202, the subsequent pass operations begin by inducting a product into the system. The OCR or other detection device reads the product identification, at step 204, and provides such information to the controller. At step 206, a determination is made as to whether the product has an identification that matches a product identification assigned in the database.

If there is a match of product information, at step 208, a determination is made as to whether the inducted product can be sorted based on an assignment of the database. Factors that may affect the sorting process include, for example, the location of the product within the stream compared is compared to the contents of the database. However, if there is no match, the product may still be sorted, if possible, based on adjacent product identification, at step 210, and whether the product was read by the detection device in previous operations. For example, if the inducted product was not read and the adjacent product identification does not match, then the product may be rejected.

Referring to FIGS. 3a and 3b, at step 100, a first pass database is generated during a first sort operational stage. At step 101, a subsequent pass operation is started. In this subsequent operational stage, X and Y counters are initialized, i.e., X=1, Y=0, where:

(i) X is representative of a product to be verified (in proper order) during the subsequent pass operational stage, and

(ii) Y is representative of a next product in the stream of sorted product.

At step 102, a determination is made as to whether the product designation of product X exceeds the database limit, i.e., X is a number larger than the last counted product assigned in the database. If the product X exceeds the limit of the database, at step 103, the process will end. However, if the product X does not exceed the limit of the database, the product X will be inducted into the system of FIG. 1 for sequencing or further sorting, at step 104.

If no product is inducted into the system at step 104, a determination is made, at step 128, whether the designation of product X equals the last assigned product in the database. If not, the process returns to step 102. However, if the determination at step 128 is affirmative, the process will continue to step 129, at which operational stage the product will be rejected as a “double”. The process then ends at step 130.

If product X is inducted into the system, a determination is made, at step 105, whether the product information of product X is the same as the product information of product X assigned in the first pass database. That is, a determination is made as to whether the product X matches, in the same order, the product which was anticipated or predicted by the database, e.g., should have been seen by the detection device and as expected in accordance with the contents of the database. If yes, at step 112, the product X is sorted to the appropriate bin based on the assignment in the database. The counter is then incremented, at step 106, and the process continues at step 102.

If the product X is not the same as the anticipated product X, the process will continue to step 107. At step 107, a determination is made as to whether the product information of product X matches any product information of the first pass database. If there is a product information match, a check will be made, at step 108, to determine whether the product X is positioned before or after product which was anticipated by the database; that is, the product which was expected to be seen by the detection device.

If the product X is before, at step 113, a determination is made as to whether the product X can be sorted based on sort scheme and sorting time. In one example, this determination may include whether a “blocking” product has already been placed in the assigned bin location, prior to the placement of the product X. As should be understood by those of skilled in the art, after reading the disclosure, the blocking product will result in the product X being placed out of sequence if placed in the same bin location of the blocking item. If there is a blocking product, then at step 114, the product X will be rejected and the process will continue to step 144. If the product X can be sorted based on sort scheme and sorting time, the product X is sorted to the destination assigned in the database (step 146).

After step 114 or step 146, a determination is made, at step 144, as to whether the designation of product X equals the last assigned product in the database. If not, the process returns to step 102. However, if the determination at step 144 is affirmative, the process will continue to step 145, at which operational stage, the X counter will be incremented by 1. The process then continues to step 102.

Returning to step 108, if the product X is inducted after the anticipated product, at step 131, a determination is made whether the first pass database assignment for product X and the previous product X−1 are the same. If these assignments are the not same, the product X−1 is rejected at step 109. If the product X and X−1 are the same or after step 109, the product X will be assigned as the product found in the first pass database and will be sorted, at step 110. At step 111, X will be equated to the first pass location number assigned in the database and the process will return to step 106, where the counter X is incremented by 1. The process will return to step 102.

Returning to step 107, if the product information of product X does not match any product information of the first pass database, the process will continue to step 115. At step 115, the counter Y will be incremented to X+1, where Y is representative of the next product in the sorted stream. The next product Y will then be inducted into the system at step 116. At step 120, a determination is made as to whether the product information of the product X was read. The product information may not have been read for various reasons such as, for example,

(i) the label information is not facing the camera or other detection device;

(ii) machine error; or

(iii) the products do not have a label.

If the product information of product X was not read, in a second or subsequent pass operation, a determination is made at step 121 whether the product Y is the same as the database product X. If so, at step 122, the product X is sorted to the assignment for product X according to the contents of the first pass database. At step 123, the product Y will also be sorted, since it is known that the product Y is the subsequent product in the stream of sorted product, e.g., product Y was read during first pass operations and is verified to be in the proper order during second or subsequent operations. At step 124, the counter for X is incremented by 2 (X=X+2), and the process returns to step 102. As should be understood, the counter X is incremented by 2 as a result of two products, X and Y, being sorted during the subsequent operational stage.

At step 120, if the product information for product X was read during the second or subsequent operational stage, at step 117, a determination is made whether the product Y is the same as the product X, as anticipated by the database. If so, the product X is rejected and the product Y is sorted at respective steps 118 and 119. The process then continues at step 106. However, if the product Y is not the same as the product X, the process will continue at step 125.

At step 125, a determination is made as to whether product Y is the same as the first pass database product Y, e.g., whether the product information of product Y is the same as the product information of product Y assigned in the first pass database. If the product Y is the same as the first pass database product Y, the process will continue at step 126, at which operational stage the product X will be rejected. The process will then sort product Y, at step 127. The process will continue at step 124. If not, the process will continue at step 132.

At step 121, if the product Y is not the same as the database product X, then at step 132 a determination is made whether product Y is represented in the first pass database. If the product Y is not represented in the first pass database, at step 153, the product X will be rejected and the counter for X will be equated to Y (X=Y) at step 134. The process will then return to step 115.

At step 132, if the product Y is represented in the first pass database, then a determination is made whether the location of product Y in the first pass database is before or after the product X, at step 135. If the location of product Y, in the stream of sorted product, is after the product X, at step 136, the product X is rejected. At step 137, the product Y is set to the location found in the database and, at step 138, the product Y is sorted as assign in the first pass database (step 138). At step 139, the counter for X will be equated to Y (X=Y) and the process returns to step 102.

At step 135, if the location of the product Y, in the stream of sorted product, is before the product X, a determination is made whether the product Y can be sorted based on sort scheme and sort time (step 140). If not, the product Y and the product X are rejected at respective steps 141 and 142. At step 143, the counter for X is then equated to Y+1 and the process returns to step 102. If the determination is affirmative at step 135, the product Y is sorted and the product X is rejected at respective steps 147 and 142. The process then continues at step 143.

### EXAMPLES of USE

The following are several examples of use showing the verification process during the second sort operational stages. These examples are provided for illustrative purposes and are not meant to be limiting to the interpretation of the claimed invention.

### Example 1

In a 1^{st} example, the Table 1 is representative of a Database generated during the 1^{st} pass operations. In this example, the database, represented in Table 1, is generated using five products, 1-5, with three destination addresses, A-C. In this example, all products return in 2^{nd} Pass in correct order.

TABLE 1

| Product ID # | Final Destination Address |
|---|---|
| 1 | A |
| 2 | B |
| 3 | B |
| 4 | B |
| 5 | C |

Utilizing the steps of FIGS. 3a and 3b and the above database representation and example, the following process provides verification and/or correction to the sort order.
Step 100: Generate Database.
Step 101: Initialize 2^{nd} Pass.
Step 102: Check for last product. This is not last product and the process thus continues.
Step 104: Feed product.
Step 105: Compare product identification of product 1 to product 1 in Database. In this case they are the same.
Step 112: Sort product to assigned address.
Step 106: Increment counter x by 1.
Steps 102, 104, 105, 112 and 106: Repeat four more times leaving x=6.
Step 102: Check for last product. In this case, the last product has arrived and the process ends.
Step 103: End.

At the end of this process, the products 1-5 are in a sequenced order and verified as shown in the following sort table.

Sort Table (Example 1)

| Product ID # | Location | Step Sort Occurred |
|---|---|---|
| 1 | A | 6 |
| 2 | B | 6 |
| 3 | B | 6 |
| 4 | B | 6 |
| 5 | C | 6 |

### Example 2

In a 2^{nd} example, Table 1 is representative of a Database generated during the 1^{st} pass operations. In this example, product 1 has been moved to a latter position such that the product stream will be presented in order 2, 3, 1, 4, 5.

Utilizing the steps of FIGS. 3a and 3b and the above database representation and example, the following process provides verification and/or correction to the sort order.
Step 100: Generate Database.
Step 101: Initialize 2^{nd} Pass.
Step 102: Check for last product. This is not the last product and the process thus continues.
Step 104: Feed product.
Step 105: Compare product 1 address (B) to Database product 1 Address (A). IN this case they are not the same.
Step 107: Check for 1^{st} occurrence of product identification (e.g., address) of product (B) in Database. In this case product 2 in Database has this product identification.
Step 108: Check if Database occurrence found in step 107 is before or after product 1. In this case it is after product 1 with product identification (B) corresponding to product 2 with product identification (B) in the Database (so its is after pointer location of 1).
Step 131: The Database product identification for 1 (A) and 0 (doesn't exist) is not the same.
Step 109: Reject product (x−1)=0. There is no product 0 so no reject happens.
Step 110: Assign product x (in this case product 1 with product identification B) as product 2 in the Database.
Step 111: Set x to the 1^{st} Pass location number, in this case x=2.
Step 106: Increment x by 1 so next product can be processed.
Step 102: Check for last product, x=3<5. This is not the last product and the process thus continues.
Step 104: Feed product.
Step 105: Check product identification of product 3 (B) with Database product 3. In this case they are the same.
Step 112: Sort product to assigned address.
Step 106: Increment x by 1 so next product can be processed.
Step 102: Check for last product, x=4<5. This is not the last product and the process thus continues.
Step 104: Feed product.
Step 105: Check product identification of product 1 (A) with Database product 4 product identification (B). In this case they are different.
Step 107: Check if product is in Database. In this case it is product 1 in Database.
Step 108: Check if Database occurrence found in step 107 is before or after pointer x=4 in Database. In this case it is before.
Step 113: Check if sort scheme or sorter limitations will allow product to sort. In this case we will say it cannot be sorted because previous addresses have been sorted.
Step 114: Reject product of sort sequence.
Step 144: X does not equal the end of Database (e.g., 4 does not equal 5).
Step 102: Check for last product. In this case x=4<5 is not greater than 5. The process thus continues.
Step 104: Feed product.
Step 105: Product identification of product 4 (B) matches with Database product 4 product identification (B).
Step 112: Sort product to Address.
Step 106: Increment x so next product can be processed x=5.
Step 102: The last product, x=5 is not greater than 5. The process thus continues.
Step 104: Feed product.
Step 105: The product identification of product 5(C) matches with Database product 5 address (C).
   Step 112: Sort product to Address
Step 106: Increment X so next product can be processed x=6
Step 102: The last product is greater, x=6>5. The process continues along the “yes” path.
Step 103: End.

At the end of this process, the product 1 is rejected and the remaining products are in a sequenced order and verified as shown in the following sort table.

Sort Table (Example 2)

| | | Step Sort |
|---|---|---|
| Product ID # | Location | Occurred |
| 2 | B | 110 |
| 3 | B | 112 |
| 1 | Rejected | 114 |
| 4 | B | 112 |
| 5 | C | 112 |

### Example 3

In a 3^{rd} example, Table 1 is representative of a Database generated during the 1^{st} pass operations. In this example, an extra product has been added to the stream, or a “double” has been singulated. The product stream will be presented in order 1, 2, 3, new product, 4, 5.

Utilizing the steps of FIGS. 3a and 3b and the above database representation and example, the following process provides verification and/or correction to the sort order.
Step 100: Generate Database.
Step 101: Initialize 2^{nd} Pass.
Step 102: Check for last product, x=1<5. This is not the last product and the process thus continues.
Step 104: Feed product.
Step 105: The product 1 address A is the same as Database Product 1 Address A.
Step 112: Sort product 1.
Step 106: Increment x to 2.
Step 102: Check for Last product, x=2<5. This is not last product and the process thus continues.
Step 104: Feed product.
Step 105: The product 2 Address B is the same as Database Product 2 Address B.
Step 112: Sort product 2.
Step 106: Increment x to 3.
Step 102: Check for last product, x=3<5. This is not the last product and the process thus continues.
Step 104: Feed product.
Step 105: The product 3 Address B is the same as Database Product 3 Address B.
Step 112: Sort product 3.
Step 106: Increment x to 4.
Step 102: Check for last product, x=4<5. This is not last product and the process thus continues.
Step 104: Feed product.
Step 105: The product 4 product identification “new product” is not the same as Database Product 4 Address.
Step 107: The product 4 is not in the Database.
Step 115: Set Y counter to x+1=5.
Step 116: Feed product.
Step 120: The product 4 was read.
Step 117: The product 5 Address B is the same as Database Product 4 Address B.
Step 118: Reject product 4.
Step 119: Sort product 5.
Step 106: Increment x to 5.
Step 102: Check for last product, x=5 is not >5. This is not the last product and the process thus continues.
Step 104: Feed product.
Step 105: The product 5 Address C is the same as Data Product 5 Address C.
Step 112: Sort product 5.
Step 106: Increment x to 6.
Step 102: Check for last product, x=6>5. This is the last product and the process thus ends.
Step 103: END

At the end of this process, the new product is rejected and the remaining products are in a sequenced order and verified as shown in the following sort table.

Sort Table (Example 3)

| Product ID # | Location | Step Sort Occurred |
|---|---|---|
| 1 | A | 112 |
| 2 | B | 112 |
| 3 | B | 112 |
| New product | Rejected | 118 |
| 4 | B | 119 |
| 5 | C | 112 |

### Example 4

In a 4^{th} example, Table 1 is representative of a Database generated during the 1^{st} pass operations. In this example, a product has been removed or a double has occurred in second pass operation. The product stream will be presented in order 1, 2, 4, 5. It will be assumed that product 3 is doubled with product 2.

Utilizing the steps of FIGS. 3a and 3b and the above database representation and example, the following process provides verification and/or correction to the sort order.
Step 100: Generate Database.
Step 101: Initialize 2^{nd} pass.
Step 102: Check for last product, x=1<5. This is not the last product and the process thus continues.
Step 104: Feed product.
Step 105: The product 1 Address A is the same as Database 1 Address A.
Step 112: Sort product 1.
Step 106: Increment x to 2.
Step 102: Check for last product, x=2<5. This is not the last product and the process thus continues.
Step 104: Feed product.
Step 105: The product 2 Address B is the same as Database product 2 Address B.
Step 112: Sort product 2.
Step 106: Increment x to 3.
Step 102: Check for last product, x=3<5. This is not the last product and the process thus continues.
Step 104: Feed product.
Step 105: The product 3 Address B is the same as Database product 3 Address B.
Step 112: Sort product 3.
Step 106: Increment x to 4.
Step 102: Check for last product, x=4<5. This is not the last product and the process thus continues.
Step 104: Feed product.
Step 105: The product 4 Address C is not the same as Database product 4 Address B.
Step 107: The product 4 Address C is in Database—Yes it is product 5.
Step 108: The product is after.
Step 131: The Database Address for product 4 (B) is the same as product 3 (B).
Step 110: Assign product 4 Address C to product 5 in Database sort and sort product.
Step 111: x=5.
Step 106: Increment x to 6.
Step 102: Check for next product, x=6>5. The process thus ends.
Step 103: End.

At the end of this process, the product are in a sequenced order and verified as shown in the following sort table.

Sort Table (Example 4)

| Product ID # | Location | Step Sort Occurred |
|---|---|---|
| 1 | A | 112 |
| 2 & 3 | B & B | 112 |
| 4 | B | 112 |
| 5 | C | 110 |

### Example 5

In a 5^{th} example, Table 1 is representative of a Database generated during the 1^{st} pass operations. In this example, a product has been removed or a double has occurred in second pass operational stage. The product stream will be presented in order 1, 2, 3, 4. It is assumed for this example that product 5 is doubled with product 4.

Utilizing the steps of FIGS. 3a and 3b and the above database representation and example, the following process provides verification and/or correction to the sort order.
Step 100: Generate Database.
Step 101: Initialize 2^{nd} pass.
Step 102: Check for last product, x=1<5. This is not the last product and the process thus continues.
Step 104: Feed product.
Step 105: The product 1 Address A is the same as Database 1 Address A.
Step 112: Sort product 1.
Step 106: Increment x to 2.
Step 102: Check for last product, x=2<5. This is not the last product and the process thus continues.
Step 104: Feed product.
Step 105: The product 2 Address B is the same as Database 2 Address B.
Step 112: Sort product 2.
Step 106: Increment x to 3.
Step 102: Check for last product, x=3<5. This is not the last product and the process thus continues.
Step 104: Feed product.
Step 105: The product 3 Address B is the same as Database 3 Address B.
Step 112: Sort product 3.
Step 106: Increment x to 4.
Step 102: Check for a last product x=4<5. This is not the last product and the process thus continues.
Step 104: Feed product.
Step 105: The product 4 Address B is the same as Database 4 Address B.
Step 112: Sort product 4.
Step 106: Increment x to 5.
Step 102: Check for last product, x=5 in not >5. This is not the last product and the process thus continues.
Step 104: Feed product—No piece fed out of mail.
Step 128: x=end of Database Quantity, x=5=5.
Step 129: Change product 4 to Reject and end the process.
Step 130 END.

At the end of this process, the double product 4 and 5 are rejected and the remaining product are in a sequenced order and verified as shown in the following sort table.

Sort Table (Example 5)

| Product ID # | Location | Step Sort Occurred |
|---|---|---|
| 1 | A | 112 |
| 2 | B | 112 |
| 3 | B | 117 |
| 4 | B | 112 |
| 4 & 5 | Reject | 129 |

### Example 6

In a 6^{th} example, Table 1 is representative of a Database generated during the 1^{st} pass operations. In this example, a product is unreadable in the second pass operational stage. The product stream will be presented in order 1, 2, ??, 4, 5. It may be assumed that, for example, this issue has been caused by a glare, smeared address, miss faced product, folded over edge, or a label applied over the destination identification (Address).

Utilizing the steps of FIGS. 3a and 3b and the above database representation and example, the following process provides verification and/or correction to the sort order.
Step 100: Generate Database.
Step 101: Initialize 2^{nd} Pass.
Step 102: Check for last product, x=1<5. This is not the last product and the process thus continues.
Step 104: Feed product.
Step 105: The product 1 Address A is the same as Database product 1 Address A.
Step 112: Sort product 1.
Step 106: Increment x to 2.
Step 102: Check for last product, x=2<5. This is not the last product and the process thus continues.
Step 104: Feed product.
Step 105 The product 2 Address B is the same as Database product 2 Address B.
Step 112: Sort product 2.
Step 106: Increment x to 3.
Step 102: Check for last product, x=3<5. This is not the last product and the process thus continues.
Step 104: Feed product.
Step 105: The product 3 Address “??” is not the same as Database Product 3 Address B.
Step 107: The product address “??” is not in Database.
Step 115: Set y counter to x+1=4.
Step 116: Feed product.
Step 120: The product 3 was not read.
Step 121: The product 4 Address B is the same as Database Product 4 Address B.
Step 122: Sort product 3 to Address B from Database.
Step 123: Sort product 4.
Step 124: Increment x to 5.
Step 102: Check for last product, x=5 is not >5. This is not the last product and the process thus continues.
Step 104: Feed product.
Step 105: The product 5 Address C is the same as Database product 5 Address C.
Step 112: Sort product.
Step 106: Increment x to 6.
Step 102: Check for last product, x=6>5. This is the last product and the process thus ends.
Step 103: END.

At the end of this process, the all of the product are in a sequenced order and verified as shown in the following sort table.

Sort Table (Example 6)

| Product ID # | Location | Step Sort Occurred |
|---|---|---|
| 1 | A | 112 |
| 2 | B | 112 |
| 3 | B | 121 |
| 4 | B | 123 |
| 5 | C | 112 |

### Example 7

In a 7^{th} example, Table 2 is representative of a Database generated during the 1^{st} pass operational stage. In this example, the database, represented in Table 2, is generated using five products of product 1-5, with five destination addresses, A-E.

TABLE 2

| Product ID # | Final Destination Address |
|---|---|
| 1 | A |
| 2 | B |
| 3 | C |
| 4 | D |
| 5 | E |

In this example, a product has been substituted for product 3. The product stream will be presented in order 1, 2, substitute, 4, 5. Utilizing the steps of FIGS. 3a and 3b and the database representation of Table 2, the following is provided:
Step 100: Generate Database.
Step 101: Initialize 2^{nd} pass.
Step 102: Check for last product, x=1<5. This is not the last product and the process thus continues.
Step 104: Feed product.
Step 105: The product 1 Address A is the same as Database product 1 Address A.
Step 112: Sort product 1.
Step 106: Increment x to 2.
Step 102: Check for last product, x=2<5. This is not the last product and the process thus continues.
Step 104: Feed product.
Step 105: The product 2 Address B is the same as Database Product 2 Address B.
Step 112: Sort product 2.
Step 106: Increment x to 3.
Step 102: Check for last product, x=3<5. This is not the last product and the process thus continues.
Step 104: Feed product.
Step 105: The product 3 Address substitute is not the same as Database Product 3 Address C.
Step 107: The product Address substitute is not in Database.
Step 115: Set y counter to x+1=4.
Step 116: Feed product.
Step 120: The product 3 was read.
Step 117: The product 4 Address D is not the same as Database Product 3 Address C.
Step 125: The product 4 Address D is the same as Database Product 4 Address D.
Step 126: Reject product 3.
Step 127: Sort product 4.
Step 124: Increment x to 5.
Step 102: Check for rest product x=5 in not >5. The process thus continues.
Step 104: Feed product.
Step 105: The product 5 Address E is the same as Database product 5 Address E.
Step 112: Sort product.
Step 106: Increment x to 6.
Step 102: Check for last product, x=6>5. This is the last product and thus the process ends.
Step 103: END.

At the end of this process, the substitute product is rejected and the remaining products are in a sequenced order and verified as shown in the following sort table.

Sort Table (Example 7)

| Product ID # | Location | Step Sort Occurred |
|---|---|---|
| 1 | A | 112 |
| 2 | B | 112 |
| Substitute | Reject | 126 |
| 4 | D | 127 |
| 5 | E | 112 |

### Example 8

In an 8^{th} example, Table 1 is representative of a Database generated during the 1^{st} pass operations. In this example, the product stream is different than in the first pass operational stage. The product stream will be 1, 2, x, y, 5.

Utilizing the steps of FIGS. 3a and 3b and the above database representation and example, the following process provides verification and/or correction to the sort order.
Step 100: Generate Database.
Step 101: Initialize Second Pass.
Step 102: Check for End of Data x=1<5. This is not the last product and the process thus continues.
Step 104: Feed product
Step 105: The product 1 Address A is the same as Database 1 Address A.
Step 112: Sort product 1.
Step 106: Increment x to 2.
Step 102: Check for end of Data x=2<5. This is not the last product and the process thus continues.
Step 104 Feed product.
Step 105 The product 2 address B is the same as Database 2 Address B.
Step 112 Sort product.
Step 106: Increment x to 3.
Step 102: Check for End of Data x=3<5. This is not the last product and the process thus continues.
Step 104: Feed product.
Step 105: The product 3 Address X is not the same as Database 3 Address B.
Step 107: The product 3 Address X is not in the Database.
Step 115: Set Y pointer to 4.
Step 116: Feed product.
Step 120: The product 3 is read.
Step 117: The product 4 Address Y is not the same as Database product 3 Address B.
Step 125: The product 4 Address Y is not the same as Database product 4 Address B.
Step 132: The product 4 Address y is not in the Database.
Step 133: Reject product 3.
Step 134: Set X to 4.
Step 115: Set Y counter to 5.
Step 116: Feed product.
Step 120: The product 4 was read.
Step 117: The product 5 Address C is not the same as Database product 4 Address B.
Step 125: The product 5 Address C is the same as Database product 5 Address C.
Step 126: Reject product 4.
Step 127: Sort product 5.
Step 124: Set x to 6.
Step 102: Check for end, x=6>5. This is the last product and thus the process ends.
Step 103: END.

At the end of this process, the products 3 and 4 are rejected and the remaining products are in a sequenced order and verified as shown in the following sort table.

Sort Table (Example 8)

| Product ID # | Location | Step Sort Occurred |
|---|---|---|
| 1 | A | 112 |
| 2 | B | 112 |
| 3 | Reject | 133 |
| 4 | Reject | 126 |
| 5 | C | 127 |

### Example 9

In a 9^{th} example, Table 1 is representative of a Database generated during the 1^{st} pass operations. In this example, product 1 has been moved to a latter position. The product stream will be presented in order 2, 3, 1, 4, 5.

Utilizing the steps of FIGS. 3a and 3b and the above database representation and example, the following process provides verification and/or correction to the sort order.
Step 100: Generate Database.
Step 101: Initialize 2^{nd} Pass.
Step 102: Check for End of Data x=1<5. This is not the last product and the process thus continues.
Step 104: Feed product.
Step 105: The product 1 Address B is not the same as Database product 1 Address A.
Step 107: Check for 1^{st} occurrence of Address of product address B in Database. In this case product 2 in Database has this Address.
Step 108 Check if 1^{st} Database occurrence found in (107) is before or after 1. In this case it is after. Fed product 1 with Address B corresponds to product 2 with Address A in the Database, so it is after the pointer (1).
Step 131 The Database Address for 1 (A) and 0 (doesn't exist) are not the same.
Step 109: Reject product (x−1)=0. There is no product 0 so no reject happens.
Step 110: Assign product x (in this case 1 with Address B) as product 2 in the Database.
Step 111: Set x to the 1^{st} pass location number, in this case x=2.
Step 106: Increment x by 1 so next product can be processed.
Step 102 Check for last product, x=3<5. This is not the last product and the process thus continues.
Step 104: Feed product.
Step 105 Check Address of product 3 (B) with Database product 3 in this case they are the same.
Step 112: Sort product 3 to assigned Address.
Step 106 Increment x by 1 so next product can be processed x=4.
Step 102 Check for last product, x=4<5. This is not the last product and the process thus continues.
Step 104 Feed product.
Step 105 The Address of product 1 (A) is different than Database product 4 Address (B).
Step 107 Check if product is in Database, in this case it is product 1 in Database.
Step 108 Check if 1^{st} Database occurrence found in step 107 is before or after pointer x=4 in Database. In this case it is before.
Step 113: Check if sort scheme or sorter limitations will allow product to sort. In this case we will say it can be sorted because previous Addresses have not been sorted.
Step 146: Sort according to first pass assignment address (A).
Step 144: x=4=end of data (5), no.
Step 102: Check for last product, x=4<5. The process thus continues.
Step 104: Feed product.
Step 105: The product identification of product 4 (B) matches with Database product 4 product identification (B).
Step 112: Sort product to Address.
Step 106: Increment x, x=5.
Step 102: Check for last product, x=5 is not greater than 5. The process thus continues.
Step 104: Feed product.
Step 105: The product identification of product 5(C) matches with Database product 5 Address (C).
Step 112: Sort product to Address.
Step 106: Increment x, x=6
Step 102: Check for next product, x=6>5. In this case the process ends.
Step 103: END.

At the end of this process, no product is rejected. The products are in a sequenced order and verified as shown in the following sort table. Because we assumed locations A, B and C are in distinctly different sort locations so no blocking piece had been sorted to location A. (If a blocking piece was sorted, A would have been rejected.)

Sort Table (Example 9)

| Product ID # | Location | Step Sort Occurred |
|---|---|---|
| 2 | B | 110 |
| 3 | B | 112 |
| 1 | A | 146 |
| 4 | B | 112 |
| 5 | C | 112 |

### Example 10

In a 10^{th} example, Table 1 is representative of a Database generated during the 1^{st} pass operations. In this example, two new products have appeared in the second pass operational stage. The order of the adjacent product is incorrect, e.g., the product order will be 1, x, y, 5, and 4. This example assumes that the product in question cannot be sorted at step 113.

Utilizing the steps of FIGS. 3a and 3b and the above database representation and example, the following process provides verification and/or correction to the sort order.
Step 100: Generate Database.
Step 101: Initiate 2^{nd} pass.
Step 102: Check for end of data x=1<5. The process thus continues.
Step 104: Feed product.
Step 105: The product 1 address A is the same as database 1 address A.
Step 112: Sort product.
Step 106: Increment x to 2.
Step 102: Check for end of data x=2<5. The process thus continues.
Step 104: Feed product.
Step 105: The product 2 Address is not the same as Database 2 Address B.
Step 107 The product 2 Address is not in Database.
Step 115: Set y pointer to 3.
Step 116: Feed product.
Step 120: The product 2 was read.
Step 117: The product 3 address Y is not the same as Database 2 Address B.
Step 125: The product 3 address Y is not the same as Database 3 Address B.
Step 132: The product 3 Address Y is not in Database.
Step 133: Reject product 2 address X.
Step 134: Set X to 3.
Step 115: Set Y to 4.
Step 116: Feed product.
Step 120: The product 3 was read.
Step 117: The product 4 Address C is not the same as Database 3 Address B.
Step 125: The product 4 Address C is not the same as Database 4 Address B.
Step 132: The product 4 Address C is in the Database.
Step 135: The location is after—after, product is 5.
Step 136: Reject product 3.
Step 137: Set Y to product location # found in step 135, Y=5.
Step 138: Sort product 5 address C.
Step 139 X is set to Y, x=5
Step 102: Check for end of Data x=5 is not greater than 5. The process thus continues.
Step 104: Feed product.
Step 105: The product 5 address B is not the same as Database 5 Address C.
Step 107: The product 5 Address B is in Database.
Step 108: The produce identification is before 5.
Step 113: In this example, it is assumed that the product cannot be sorted based on sort scheme and time.
Step 114: Reject product 5.
Step 144 Does X=End of Database—Yes
Step 145: X=6.
Step 102 Last product was processed and thus the process ends.
Step 103 END

Assuming that the products in question could not be sorted at step 113, at the end of this process, the product X, Y and 4 are rejected and the remaining products are in a sequenced order and verified as shown in the following sort table.

Sort Table (Example 10)

| Product # | Location | Step in Process |
|---|---|---|
| 1 | A | 112 |
| X | Reject | 133 |
| Y | Reject | 136 |
| 5 | C | 138 |
| 4 | Reject | 113 |

### Example 11

In an 11^{th} example, Table 1 is representative of a Database generated during the 1^{st} pass operations. In this example, in the second pass operational stage. The order of the adjacent product is incorrect, e.g., the product order will be 1, x, y, 5, and 4. However, unlike example 10, this example assumes that the product in question can be sorted at step 113.

Utilizing the steps of FIGS. 3a and 3b and the above database representation and example, the following process provides verification and/or correction to the sort order.
Step 100: Generate Database.
Step 101: Initiate 2^{nd} pass.
Step 102: Check for end of data x=1<5. The process thus continues.
Step 104: Feed Product.
Step 105: The Product 1 address A is the same as Database 1 Address A.
Step 112: Sort product.
Step 106: Increment X to 2.
Step 102: Check for end of data x=2<5. The process thus continues.
Step 104: Feed product.
Step 105: The product 2 Address x is not the same as Database 2 Address B.
Step 107: The product 2 Address X is not in Database.
Step 115: Set y pointer to 3.
Step 116: Feed product.
Step 120: The product 2 was read.
Step 117: The product 3 Address Y is not the same as Database 2 Address B.
Step 125: The product 3 Address Y is not the same as Database 3 Address B.
Step 132: The product 3 Address Y is not in the Database.
Step 153: Reject product 2 Address X
Step 134: Set X to 3.
Step 115: Set Y to 4.
Step 116: Feed product.
Step 120: The product 3 was read.
Step 117: The product 4 Address C is not the same as Database 3 Address B.
Step 125: The product 4 Address C is not the same as Database 4 Address B.
Step 132: The product 4 Address C is in the Database.
Step 135: The location is after 3—after, product is 5
Step 136: Reject product 3.
Step 137: Set Y to product location # found in step 135, y=5.
Step 138: Sort product 4 address C.
Step 139: X is set to Y x=5.
Step 102: Check for end of Data x=5 is not greater than 5. The process thus continues.
Step 104: Feed product.
Step 105: The product 5 Address B is not the same as Database 5 Address C.
Step 107: The product 5 Address B is in Database.
Step 108: The product is before 5.
Step 113: In this example, it is assumed that the product can be sorted based on sort scheme and time.
Step 146: Sort product 5.
Step 144: Does x=end of Database—Yes.
Step 145: x=6.
Step 102: Check for end of Data—Yes.
Step 103: END.

Assuming that the products in question could be sorted 113, and the product X, Y are rejected, the remaining products are in a sequenced order and verified as shown in the following sort table.

Sort Table (Example 11)

| Product # | Location | Step in Process |
|---|---|---|
| 1 | A | 112 |
| X | Reject | 153 |
| Y | Reject | 136 |
| 5 | C | 138 |
| 4 | B | 146 |

### Example 12

In a 12^{th} example, Table 1 is representative of a Database generated during the 1^{st} pass operations. In this example, the product sequence 1, X, Y, 1, 4.

Utilizing the steps of FIGS. 3a and 3b and the above database representation and example, the following process provides verification and/or correction to the sort order.
Step 100: Generate Database.
Step 101: Initiate 2nd pass.
Step 102: Check for end of Data x=1<5. The process thus continues.
Step 104: Feed product.
Step 105: The product 1 Address A is the same as Database 1 Address A.
Step 112: Sort product.
Step 106: Increment X to 2.
Step 102: Check for end of Data x=2<5. The process thus continues.
Step 104: Feed product.
Step 105: The product 2 Address X is not the same as Database 2 Address B.
Step 107: The product 2 Address X us not in Database.
Step 115: Set Y pointer to 3.
Step 116: Feed product.
Step 120: The product 2 was read.
Step 117: The product 3 Address Y is not the same as Database 2 Address B.
Step 125: The product 3 Address Y is not the same as Database 3 Address B.
Step 132: The product 3 Address Y is not in the Database.
Step 133: Reject product 2 Address X.
Step 134: Set X to 3.
Step 115: Set Y to 4.
Step 116: Feed product.
Step 120: The product 3 was read.
Step 117: The product 4 Address A is not the same as Database 3 Address B.
Step 125: The product 4 Address A is not the same as Database 4 Address B.
Step 132: The product 4 Address A is in the Database.
Step 135: The location is before 3.
Step 140: It is assumed in this example that the product cannot be sorted.
Step 141: Reject product 4.
Step 142: Reject product 3.
Step 143: Set x=5.
Step 102: Check for end of Data x=5 is not greater than 5. The process thus continues.
Step 104: Feed product.
Step 105: The product 5 Address B is not the same as Database 5 Address C.
Step 104: The product 5 Address B is in Database.
Step 108: The product is before product 5.
Step 113: It is assumed in this example that the product can be sorted.
Step 146: Sort product.
Step 144: X=end of Database (Yes).
Step 145: X=6.
Step 102: The end of the Database (Yes).
Step 103: END.

At the end of this process, the product X, Y and the 2^{nd} product 1 are rejected and the remaining products are in a sequenced order and verified as shown in the following sort table.

Sort Table (Example 12)

| Product # | Location | Step Sort Occurred |
|---|---|---|
| 1 | A | 112 |
| X | Reject | 133 |
| Y | Reject | 142 |
| 1 | Reject | 141 |
| 4 | B | 146 |

### Example 13

In a 13^{th} example, Table 1 is representative of a Database generated during the 1^{st} pass operations. In this example, the product sequence is 1, X, Y, 1, 4.

Utilizing the steps of FIGS. 3a and 3b and the above database representation and example, the following process provides verification and/or correction to the sort order.
Step 100: Generate Database.
Step 101: Initiate 2^{nd} pass.
Step 102: Check for END of Database, X=1<5. The process thus continues.
Step 104: Feed product.
Step 105: The product 1 Address A is the same as Database 1 Address A.
Step 112: Sort product.
Step 106: Increment X to 2.
Step 102: Check for end of Data X=2<5. The process thus continues.
Step 104: Feed product.
Step 105: The product 2 Address X is not the same as Database 2 Address B.
Step 107: The product 2 Address X is not in Database.
Step 115: Set Y pointer to 3.
Step 116: Feed product.
Step 120: The product 2 was read.
Step 117: The product identification of product 3 (Y) is not the same as Database 2 Address (B).
Step 125: The product identification of product 3 (Y) is not the same as Database 3 Address B.
Step 132: The product 3 Address Y is not in the Database.
Step 153: Reject Product 2 Address X.
Step 134: Set X to 3.
Step 115: Set Y to 4.
Step 116: Feed product.
Step 120: The product 3 was read.
Step 117: The product 4 Address A is not the same as Database 3 Address B.
Step 125: The product 4 Address A is not the same as Database 4 Address B.
Step 132: The product 4 Address A is in the Database.
Step 135: The location of the product is before 3.
Step 140: In this example, it is assumed that product 4 can be sorted.
Step 147: Sort product 4.
Step 142: Reject product 3.
Step 143: Set X=5.
Step 102: Check for ends of Data X=5 is not greater than 5. The process thus continues.
Step 104: Feed product.
Step 105: The product 5 Address B is not the same as Database 5 Address C.
Step 107: The product 5 Address B is in the Database.
Step 108: The product is before product 5.
Step 113: In this example, it is assumed that the product can be sorted.
Step 146: Sort product.
Step 144: X=end of Database (Yes).
Step 145: X=6.
Step 102: END of Database (Yes).
Step 103: END.

At the end of this process, the product X and Y are rejected and the remaining products are in a sequenced order and verified as shown in the following sort table. In this example, note that the 2^{nd} product 1 is sequenced.

Sort Table (Example 13)

| Product # | Location | Step Sort Occurred |
|---|---|---|
| 1 | A | 112 |
| X | Reject | 153 |
| Y | Reject | 142 |
| 1 | A | 147 |
| 4 | B | 146 |

While the invention has been described in terms of embodiments, those skilled in the art will recognize that the invention can be practiced with modification within the spirit and scope of the appended claims.

It is claimed:

1. A method of confirming an ordering of products, comprising:
generating a database of product information associated with a plurality of product;
inducting the plurality of product for a sorting pass process; and
comparing the product information of the plurality of product in the sorting pass process to the product information assigned in the database to verify an order of the plurality of product in the sorting pass process.

2. The method of claim 1, further comprising sequencing at least some of the plurality of product in the sorting pass process based on the comparing of the plurality of product to the product information.

3. The method of claim 1, further comprising:
determining whether product information of a discrete product of the plurality of product matches any of the product information populated in the database;
if yes, determining whether the adjacent product of the plurality of product assigned in the database is before or after the discrete product; and
if the discrete product is before, sorting the discrete product to an assignment designated in the database.

4. The method of claim 2, further comprising determining whether a blocking product is present prior to the sorting of the discrete product and, if present, rejecting the discrete product.

5. The method of claim 1, further comprising:
determining whether product information of a discrete product of the plurality of product matches any of the product information populated in the database;
if yes, determining whether adjacent product of the plurality of product assigned in the database is before or after the discrete product; and
if the discrete product is after, determining whether the product information for the discrete product is the same as the product information for a previous product, designated X−1 in the database, where X is representative of the discrete product.

6. The method of claim 5, wherein:
if the product information of the discrete product is not the same as the product information for the product X−1, then reject the product X−1 and sort the discrete product; and
if the product information of the discrete product is the same as the product information for the product X−1, then sort the discrete product.

7. The method of claim 1, further comprising determining whether the product information of a discrete product of the plurality of product corresponds to a same location of the product information of a same product of the plurality of the product assigned in the database and, if yes, sorting the discrete product in a sequence with other product.

8. The method of claim 1, further comprising determining whether a discrete product of the plurality of product has a designated number larger than that assigned in the database, and, if no, proceed to the inducting step.

9. The method of claim 1, further comprising initializing counter, X and Y, in the sorting pass process, where:
(i) X is representative of a discrete product which is to be verified as with an assignment made in the database during the sorting pass process, and
(ii) Y is representative of a next product in a stream of sorted product of the plurality of product.

10. The method of claim 9, further comprising making a determination as to whether a designation of the discrete product exceeds a limit of the database.

11. The method of claim 10, further comprising:
inducting the discrete product to the sorting pass process when the discrete product does not exceed the limit of the database; and
making a determination to whether the product information of the discrete product is at a same location as assigned in the database, and
if yes, sorting the discrete product in a sequence with other product; and
if no, determining whether the product information of the discrete product matches any product information assigned in the database.

12. The method of claim 11, further comprising, when the determination is no:
incrementing the Y counter to Y=X+1; and
inducting a next product of the plurality of product into the sorting pass process; and
making a determination as to whether the product information of the discrete product was read.

13. The method of claim 12, further comprising, when the product information was not read:
determining whether the product information of the next product is the same as the product information of the discrete product assigned in the database;
if the determination is affirmative, sorting the discrete product and the next product in order and incrementing the X counter by 2; and
if the determination is negative, making a determination as to whether the product information of the next product is represented in the database.

14. The method of claim 13, further comprising, when the determination is negative and the product information is not represented in the database, rejecting the discrete product, setting X=Y and returning to the steps of claim 12.

15. The method of claim 12, further comprising, when the product information was read, determining whether the product information of the next product is the same as the product information of the discrete product assigned in the database and, if yes, rejecting the discrete product and sorting the next product.

16. The method of claim 15, further comprising incrementing the X counter by 1 and returning to the steps of claim 1.

17. The method of claim 12, further comprising, when the product information was read:
determining whether the product information of the next product is the same as the product information of the discrete product assigned in the database; and
if not, determining whether the product information of the next product is the same as the product information of the next product assigned in the database, and if the product information is the same, rejecting the discrete product, sorting the next product and incrementing the X counter by 2.

18. The method of claim 12, further comprising, when the product information was read:
determining whether the product information of the next product is the same as the product information of the discrete product assigned in the database;
if not, determining whether the product information of the next product is represented in the database, and if the product information is represented in the database, making a determination as to whether the product information of the next product before or after the product information of the discrete product as assigned in the database.

19. The method of claim 18, further comprising, when the location is after,
rejecting the discrete product;
setting the Y counter to a location found in the database;
sorting the next product to a location assigned by the database; and
setting Y=X.

20. The method of claim 18, further comprising, when the location is before, determining whether the next product can be sorted based on a blocking product at the assigned location.

21. The method of claim 20, further comprising:
if there is no blocking product, sorting the next product and rejecting the discrete product; and
if there is a blocking product, rejecting the next product and the discrete product.

22. The method of claim 18, further comprising,
if determining whether the product information of the next product is not the same as the product information of the discrete product assigned in the database;
then, prior to determining whether the product information of the next product is represented in the database, determining whether the product information of the next product is the same as the product information of the next product assigned in the database.

23. The method of claim 1, wherein the plurality of product are mail pieces.

24. A process for increasing machine efficiency, comprising:
reading pertinent information associated with a plurality of product during a sorting operation;
populating a database with the pertinent information for use during a subsequent sorting operation;
reading the pertinent information associated with the plurality of product during the subsequent sorting operation;
accessing the database and comparing what is actually read during the subsequent sorting operation against what should have been read based on assignments made in the database of the pertinent information during the sorting operation; and
sequencing the plurality of product based on the comparing step.

25. The process of claim 24, wherein the accessing and comparing steps verify an order of the plurality of product in the subsequent sorting operation.

26. The process of claim 24, further comprising directing a discrete product of the plurality of product to an assigned bin location, for sequencing, when there is a match of the pertinent information in the comparing step.

27. The process of claim 24, further comprising:
determining whether the pertinent information of a discrete product of the plurality of product matches any of the pertinent information populated in the database;
if there is a match, determining whether an adjacent product of the plurality of product assigned in the database is before or after the discrete product; and
if the discrete product is before and there is no blocking product in an assigned bin location, sorting the discrete product to the assigned bin location designated in the database;
if the discrete product is after, determining whether the pertinent information for the discrete product is the same as the pertinent information for a previous product, designated X−1 in the database, where X is representative of the discrete product, wherein
if the pertinent information of the discrete product is not the same as the pertinent information for the product X−1, then reject the product X−1 and sort the discrete product; and
if the pertinent information of the discrete product is the same as the pertinent information for the product X−1, then sort the discrete product.

28. The process of claim 24, further comprising initializing counters, X and Y, where:
(i) X is representative of a discrete product, and
(ii) Y is representative of a next product.

29. The process of claim 28, further comprising:
making a determination as to whether a designation of the discrete product exceeds a limit of the database;
inducting the discrete product to the subsequent sorting operation when the discrete product does not exceed the limit of the database; and
making a determination to whether the pertinent information of the discrete product is at a same location as assigned in the database, and
if yes, directing the discrete product to an assigned bin location with other product in a sequence; and
if no, determining whether the pertinent information of the discrete product matches any pertinent information assigned in the database, when there are no matches:
incrementing the Y counter to Y=X+1;
inducting a next product of the plurality of product into the subsequent sorting operation; and
making a determination as to whether the pertinent information of the discrete product in the subsequent sorting operations was a “no” read.

30. The process of claim 29, further comprising, when the pertinent information of the discrete product is a no read:
determining whether the pertinent information of the next product is the same as the pertinent information of the discrete product assigned in the database, and
if yes, directing the discrete product and the next product to assigned bin locations for sequencing and incrementing the X counter by 2; and
if no, determining whether the pertinent information of the next product is assigned in the database, and
if the pertinent information of the next product is not assigned in the database, then reject the discrete product; and
if the pertinent information of the next product is in the database, then determine whether the location of the next product is before or after the location of the discrete product.

31. The process of claim 30, further comprising:
when the location is after:
rejecting the discrete product;
setting the Y counter to a location found in the database;
sorting the next product to a location assigned by the database; and
setting Y=X; and
when the location is before:
determining whether the next product can be sorted based on a blocking product at the assigned location, and
if there is no blocking product, sorting the next product and rejecting the discrete product; and
if there is a blocking product, rejecting the next product and the discrete product.

32. The process of claim 29, further comprising, when the pertinent information is read:
determining whether the pertinent information of the next product is the same as the pertinent information of the discrete product assigned in the database, and
if yes, directing the next product to an assigned bin location and rejecting the discrete product and incrementing the X counter by 1;
if not, determining whether the pertinent information of the next product is in the database and, if not, rejecting the discrete product.

33. The process of claim 24, wherein the plurality of product are mail pieces.

34. A computer program product to increase an accuracy of sorting operations, comprising a computer usable medium having a computer readable program code embodied in the medium, the computer program product including at least one module which:
generates a database of pertinent information associated with a plurality of product in a sorting operation; and
compares the pertinent information of the plurality of product in a subsequent sorting pass process to the pertinent information assigned in the database to verify an order of the plurality of product in the subsequent sorting pass process.
